(19) United States
(12) Patent Application Publication
(10) Pub. No.: US 2015/0309640 A1
(43) Pub. Date: Oct. 29, 2015

(54) TOUCH SENSITIVE CONTROL FOR A TOOL

(71) Applicant: ROBERT BOSCH TOOL CORPORATION, Broadview, IL (US)

(72) Inventor: Miroslav VUCKOVIC, Skokie, IL (US)

(21) Appl. No.: 14/693,178

(22) Filed: Apr. 22, 2015

Related U.S. Application Data
(60) Provisional application No. 61/983,081, filed on Apr. 23, 2014.

(51) Int. Cl. G06F 3/041; H02P 31/00; G06F 3/01; B25F 5/00

(52) U.S. Cl. CPC G06F 3/0414; B25F 5/00; H02P 31/00; G06F 3/017

(57) ABSTRACT

A tool comprises a housing, a tactile sensing device that is coupled to a portion of the housing and that is configured to detect at least one of a position sensing, gesture sensing, and pressure sensing for the tool, a memory that is configured to store information related to a profile, and a processor that is in communication with the tactile sensing device and the memory. The processor may be configured to monitor an output signal from the tactile sensing device when at least one of a position, gesture or pressure is detected and to retrieve the profile from the memory, compare the output signal from the tactile sensing device with the retrieved profile, and generate a second signal based upon the comparison.

### CROSS-REFERENCE TO RELATED APPLICATIONS

The patent application claims priority from U.S. provisional patent application Ser. No. 61/983,081, filed on Apr. 23, 2014 and entitled “Touch Sensitive Control for a Power Tool”, the contents of which is hereby incorporated by reference herein in its entirety.

### BACKGROUND

This disclosure relates generally to the field of tools, and more particularly to tactile control sensing devices or mechanisms for controlling the operation of power tools or sensing tools.

Portable, handheld power tools typically include a housing which encloses a drive system, such as an electric motor. The electric motor is configured to impart a drive motion to an output member, such as an output shaft. The output shaft is in turn configured to retain some type of work element which is designed to perform a certain function, such as cutting, drilling, driving, sanding, grinding, and the like, when the output shaft is driven by the motor.

In most portable, handheld power tools, power to the drive system is controlled by a mechanical switch, such as toggle switch, located on the handle or gripping portion of the tool. In power tools that have one direction and one speed of operation, the switch may be a simple two position switch to turn the motor on and off. Some power tools are capable of variable speed operation and/or bidirectional operation. In these cases, multiple switch mechanisms are often used to control the direction, speed, and power to the tool. Using multiple switches may be cumbersome. Similar situations arise with reference to sensing tools.

Therefore, there is a need for a tool that has improved control of the functions of such tools.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

Embodiments of the disclosure related to systems and methods for providing a tool that comprises a housing, a tactile sensing device that is coupled to a portion of the housing and that is configured to detect at least one of a position sensing, gesture sensing, and pressure sensing for the tool, a memory that is configured to store information related to a profile, and a processor that is in communication with the tactile sensing device and the memory. The processor may be configured to monitor an output signal from the tactile sensing device when at least one of a position, gesture or pressure is detected and to retrieve the profile from the memory, compare the output signal from the tactile sensing device with the retrieved profile, and generate a second signal based upon the comparison.

Certain embodiments of the disclosure also include the following method for controlling a tool. Sensing a signal on a tactile sensing device, transmitting or retrieving the sensed signal to the processor, retrieving data including a profile from memory, comparing the retrieved data with the sensed signal, and generating a second signal based upon the comparison of the sensed signal that has been transmitted to the processor to data retrieved from the memory.

### BRIEF DESCRIPTION OF THE DRAWINGS

These and other features, aspects, and advantages of this disclosure will become better understood when the following detailed description of certain exemplary embodiments is read with reference to the accompanying drawings in which like characters or reference numerals represent like parts throughout the drawings, wherein:

FIG. 1 depicts an embodiment of a power tool including a touch sensitive control mechanism or device in accordance with the disclosure.

FIG. 2 is a schematic diagram of the power system of the power tool of FIG. 1.

FIG. 3 illustrates an exemplary circular saw including a touch sensitive control device according to various embodiments.

FIG. 4 illustrates an exemplary rotary tool including a touch sensitive control device according to various embodiments.

FIG. 5 illustrates an exemplary router including a touch sensitive control device according to various embodiments.

FIG. 6 illustrates an exemplary drill driver including a touch sensitive control device according to various embodiments.

FIG. 7 illustrates an exemplary reciprocating saw including a touch sensitive control device according to various embodiments.

FIG. 8 illustrates an exemplary sensing tool including a touch sensitive control device according to various embodiments.

FIG. 9 is a simplified schematic diagram of the sensing tool of FIG. 8.

FIG. 10 illustrates various types of gesture profiles.

FIG. 11 is a flowchart that illustrates tactile control sensing for controlling operation of the power tool or sensing tool according to various embodiments of the disclosure.

### DETAILED DESCRIPTION OF SPECIFIC EMBODIMENTS

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such development effort might be complex and time consuming, but would nevertheless be a routine undertaking of design, fabrication, and manufacture for those of ordinary skill having the benefit of this disclosure.

The disclosure is directed to a touch sensitive, tactile control mechanism or device for a tool such a power tool in place of a conventional trigger mechanism or power switch. The tactile control mechanism or device is configured to detect contact by the fingers of the operator's hand and to generate control signals based on the parameters of the contact which may be used to control the speed and direction of the motor of the tool.

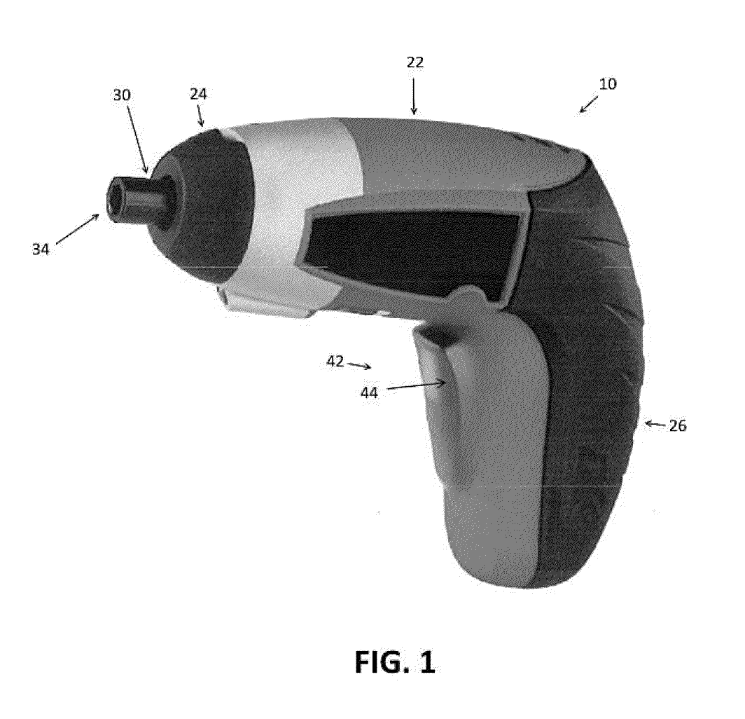

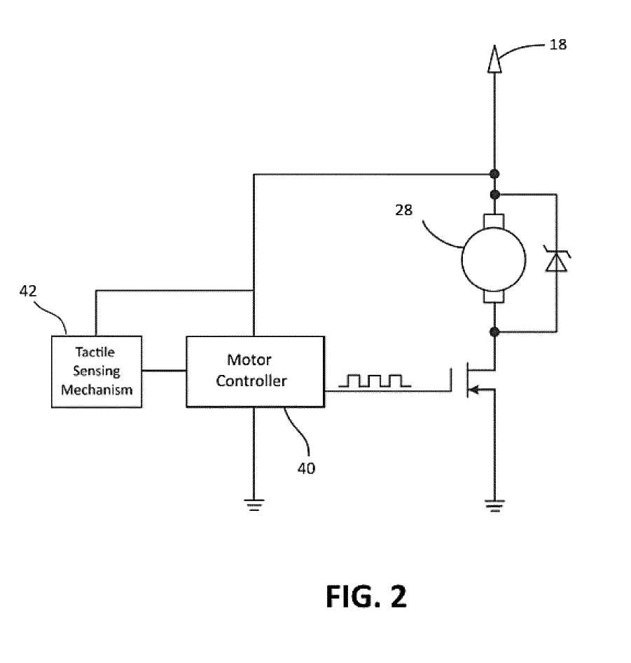

An embodiment of a power tool including a tactile control mechanism in accordance with the disclosure is depicted in FIG. 1. The power tool 10 includes a generally cylindrically shaped housing 22 having a nose portion 24 and a handle portion 26. The housing 22 encloses a motor 28 (FIG. 2). In one embodiment, the motor 28 comprises an electric motor configured to receive power from a power source 18, such as a rechargeable battery enclosed within housing 22. The rechargeable battery can be a li-ion battery, a li-air battery, a li-oxygen battery, a li-sulfur battery or the like. In other embodiments, electric power for the motor may be received from an AC outlet via a power cord or a USB connection (not shown).

The motor 28 is coupled to a drive member 30 that extends from the nose portion 24 of the housing. The drive member 30 includes a tool holder 34 that is configured to releasably retain various tool bits and accessory tools (not shown) exterior to the nose portion 24 of the housing 22. As the tool holder 34 is rotated by the drive member 30, a tool bit or accessory tool installed in the tool holder is driven to rotate to perform work. In one embodiment, the tool holder 34 comprises a hexagon-shaped socket configured to receive similarly sized hexagon-shaped accessories and tool bits although any suitable type of tool holding mechanism, including chucks and collets for example, may be utilized.

The motor 28 comprises a bi-directional variable speed motor that is configured to rotate the drive member 30 at variable speeds in both a forward direction and a reverse direction. As depicted in FIG. 2, a motor controller 40 controls the speed and direction of rotation of the motor 28. As noted above, the motor 28 is controlled based on control signals received from a tactile sensing mechanism 42 provided on the handle portion 26 of the tool housing. The tactile sensing mechanism 42 is configured to sense contact from an operator's finger and to generate control signals for the motor based on the parameters of the contact.

The tactile sensing mechanism or device 42 includes a sensing surface 44 located on the handle portion 26. In alternative embodiment, the sensing surface 44 may be formed as part of the outer wall of the handle, the outer wall of the housing, logo, other than handle portion. The sensing surface defines the region where contact from the user's finger(s) or gesture is sensed. Tactile sensing in the region of the sensing surface may be implemented in a variety of ways, including mechanical, resistive element, capacitive element, magnetic element, projected capacitive element, flexible substrate with conductive thin film, flexible substrate with electrode, foldable substrate with conductive layer, foldable substrate with electrode, optical based device, and combination thereof. The type of tactile sensing implemented depends in part on the type(s) of tactile parameters that are to be used as the basis for the motor control signals.

In one embodiment, the tactile sensing mechanism 42 is configured to output signals indicating the position or positions on the sensing surface that are being contacted by the user's finger(s). Other signals may indicate a gesture that is made on the sensing surface, a pressure that is exerted on sensing surface, etc. that varies over time. In some cases, the pressure sensing varies in position over time, varies in the amount of pressure over time, etc. The motor controller 40 receives the signals from the tactile sensing mechanism 42 and controls the motor based on the position(s) indicated by the signals. Variable speed and direction control may be implemented by assigning different positions and/or sequences of positions (e.g. gestures) on the sensing surface to different control parameters. Variable speed and direction control may also be implemented by assigning a parameter of the contact, such as pressure or force exerted on the sensing surface, to indicate changes in control parameters. A number of different control schemes may be implemented in this manner.

In one embodiment, a first location on the sensing surface may be assigned to indicate forward rotation and a second location on the sensing surface may be assigned to indicate a reverse rotation. Variable speed control may be implemented by detecting changes in the position of the contact after initial contact is detected. For example, initial tactile contact on the left edge of the sensing surface may be assigned to indicate forward rotation. After the initial contact on the left edge, forward rotation speed may be increased by swiping across the sensing surface toward the right edge with the speed of forward rotation being based on the position of the contact between the left and right edges. Similarly, initial tactile contact on the right edge of the sensing surface may be assigned to indicate reverse rotation. After the initial contact on the right edge, reverse rotation speed may be increased by swiping across the sensing surface toward the left edge with the speed of reverse rotation being based on the position of the contact between the left and right edges. Motor stoppage may be indicated when no contact is detected, such as when the user lifts there finger(s) on the sensing surface.

In another embodiment, a first location on the sensing surface may be assigned to indicate forward rotation and a second location on the sensing surface may be assigned to indicate a reverse rotation. In this embodiment, variable speed control may be implemented by detecting changes in pressure or force exerted on the sensing surface after initial contact is detected. In this embodiment, initial tactile contact on the left edge of the sensing surface may be assigned to indicate forward rotation, and initial contact on the right edge of the sensing surface may be assigned to indicate reverse rotation. After the initial contact on the left or right edge, a pressure or force on the sensing surface is detected by the tactile sensing mechanism and changes in the detected pressure or force are used as the basis for increasing and/or decreasing the speed of rotation. Any suitable type of pressure and/or force sensing mechanism may be used. It is contemplated that initial contact with or near any extremity of the tactile sensing device may be used. Usually, different actions are taken depending on which extremity is touched. For the power tool application, the signal generated by the processor when an extremity of the tactile sensing device is touched causes the motor to change direction or speed.

Changes in the modes of operation such as motor speed or motor direction are typically accomplished by comparing a profile stored in memory to a signal associated with touching the tactile sensing device near one or more of its extremities. If there is a match, then an action associated with that profile is executed. This may mean changing the speed of the motor from a first speed to a second speed or its direction from a first direction to a second direction.

The tactile sensing device may be configured to sense a pressure profile, so called, because it relates how the pressure changes relative to another variable. That is to say, the pressure may vary over time. For example, the pressure may increase or decrease over time, that is to say, there is a pressure gradient over time. Or, the pressure may vary in position over time. In such a case, this pressure profile may be referred to as a gesture profile. In other cases, the pressure may simply vary in position regardless of the timing or duration or there could be a pressure gradient across the surface of the tactile sensing device. Such profiles may be stored in a database in memory or found elsewhere. Linked to these profiles in memory could be actions that are to be executed if a certain pressure profile is detected. Other profiles stored in memory could be a gesture profile, position profile, contact profile, tool information, user information, instructions, sensory data, angle values, and offset values. In some cases, the profile stored in memory includes the amount of pressure or a pressure gradient.

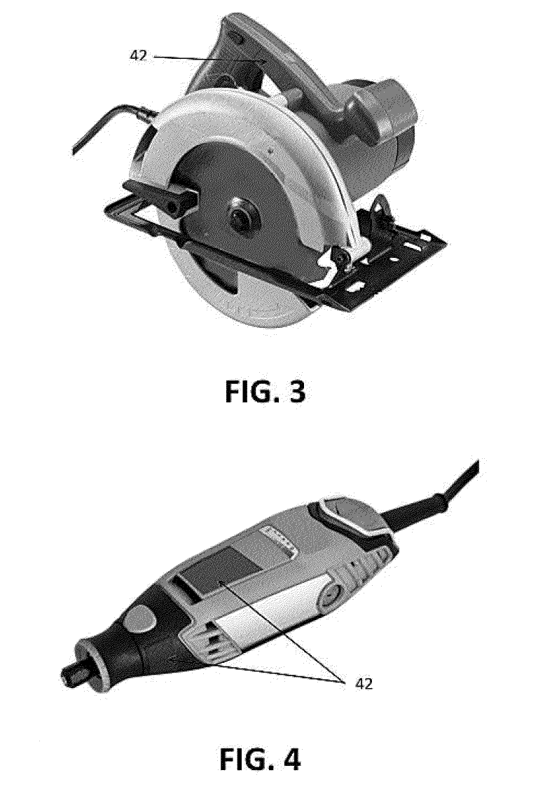

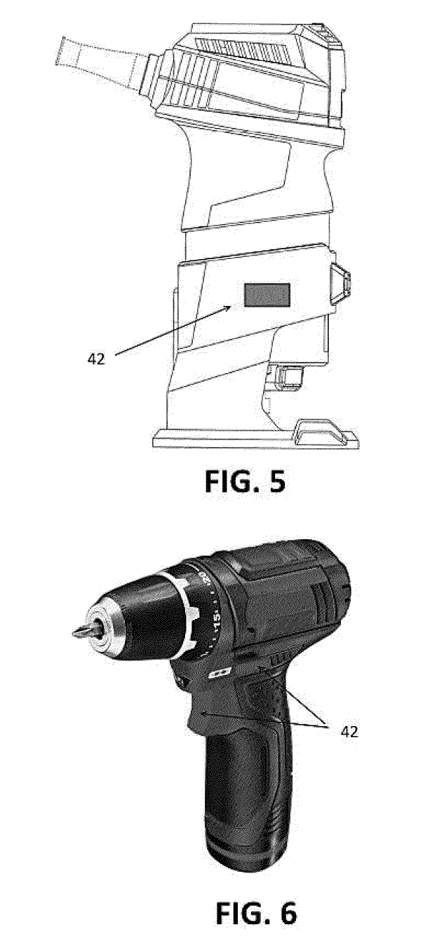

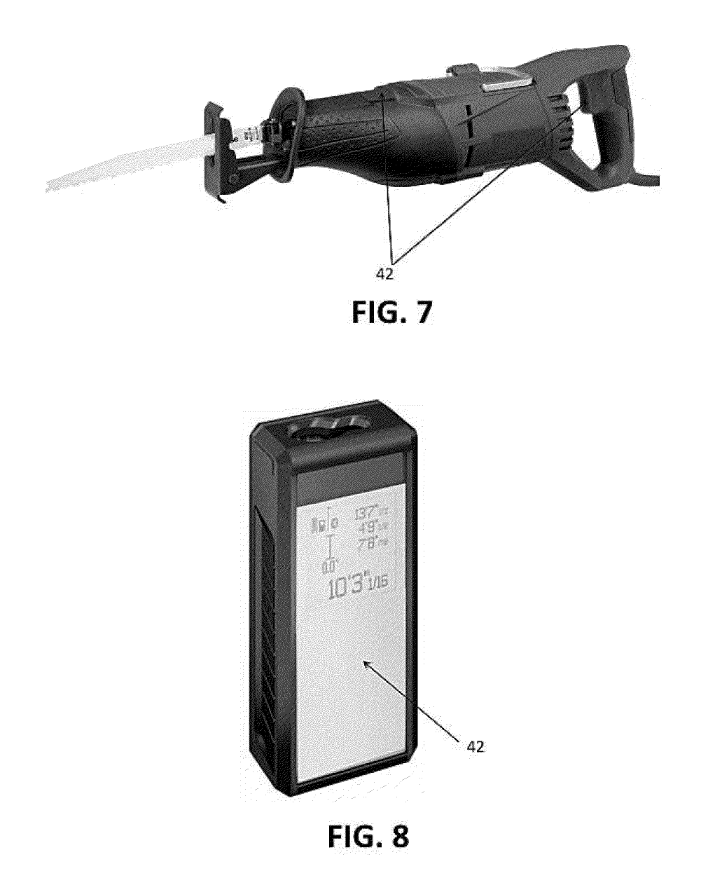

FIGS. 3-7 illustrate various exemplary power tools driven by motor assembly including a touch sensitive control device in accordance with the disclosure. The power tools include circular saws (FIG. 3), rotary tools (FIG. 4), routers (FIG. 5), drill drivers (FIG. 6), and reciprocating saws (FIG. 7). Although not depicted, touch sensitive control devices may be incorporated into other power tools, including jig saws, oscillating tools, hammers, or the like. As can be seen in FIGS. 3-7, a touch sensitive control device or control pad 42 may be incorporated onto a power tool at any location or multiple locations for access by a user.

Touch sensitive control devices may also be incorporated into other types of devices, such as sensing tools or devices, which perform a sensing function but do not necessarily perform a work function. For example, FIG. 8 illustrates an exemplary sensing tool including a touch sensitive control device according to various embodiments. The sensing tool can be a laser leveling tool, a rotation tool, a stud finder tool, a mold finder tool, a measuring tool, or the like. The sensing tool includes a tactile control device 42, similar to the device 42 disclosed in FIGS. 1-7.

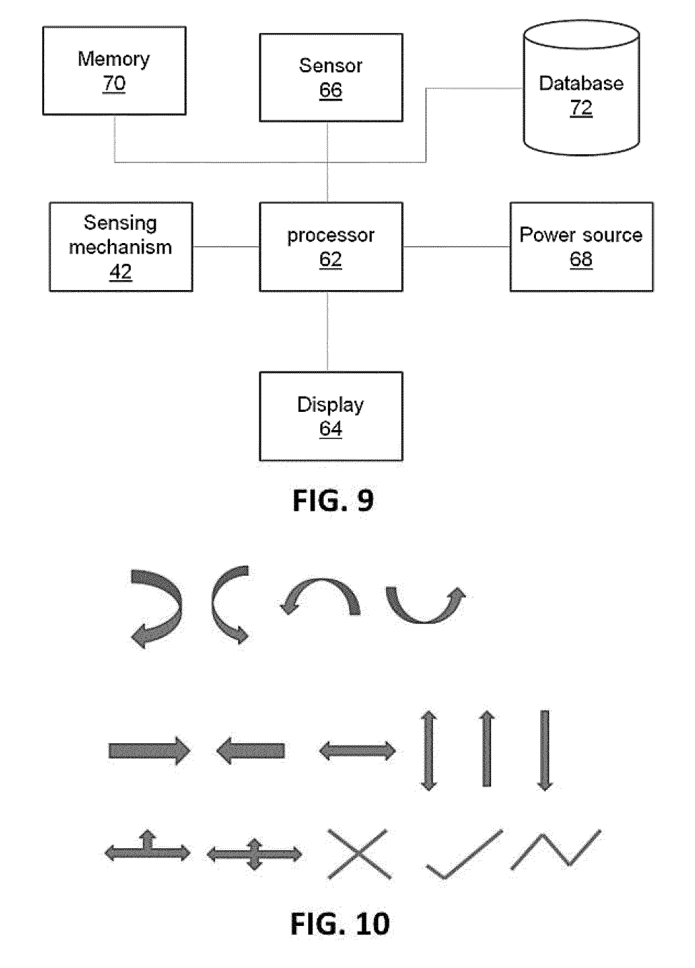

FIG. 9 is a simplified schematic diagram of the sensing tool of FIG. 8. Beside the tactile control mechanism 42, described in FIGS. 1-3 and 8, the sensing tool further includes a processor 62, a display 64, a sensor 66, power source 68, memory 70, and a database 72. The sensing tool may include other components such as transceiver, navigation system, antenna, USB interface, multiplexer or the like to provide wired/wireless communication and navigation features. The components within the sensing tool are powered by a rechargeable battery such as a li-ion battery, a li-air battery, a li-oxygen battery, a li-sulfur battery or the like. In other embodiments, the sensing tool can be powered via the USB interface (not shown). The USB interface can be used for other purposes such as programming the processor 62 with new software or new application. The database 72 stores information related to gesture profile or other pressure profile, tool, etc. The information to the tool includes year built, model number, serial number, brand, usage, remaining life of the tool, etc. The information also includes user's profile.

It should be noted that the simplified schematic diagram of FIG. 9 may be modified to represent the components of another tool such a power tool. In such a case, the memory may have a pressure profile or plurality of pressure profiles stored in a database located in the memory. Alternatively, this database may be located elsewhere. Other types of profiles may be stored as previously described. The processor for any embodiment discussed herein may be configured to implement or perform a method. This method could comprise the steps of receiving a pressure signal from the tactile sensing device, retrieving data that includes a pressure profile from memory; comparing the pressure profile data with the transmitted signal, and generating a second signal based upon the comparison of the sensed pressure signal to the pressure profile data from memory.

The sensing mechanism senses the input signal from the user and transmits the detected signal to the processor 62. The processor 62 looks up the gesture profile or other pressure profile in the database or memory, compares the profile with the detected signal, processes the signal, and causes the display 64 to display the processed information or second signal generated by the processor in various forms including as human readable format. The format can be in the form of text, numeric, audio, video, gauge, graphic, chart, LED, color, picture, or the like, either static or dynamic. The processor 62 also causes the sensor 66 to read the information external to the tool, and causes the display 64 to display the processed information in human readable format. The sensor 66 can be an optical sensor, a radio frequency (RF) sensor, an infrared (IR) sensor, a thermo or temperature sensor, an acoustic sensor, a motion sensor, a position sensor, a moisture sensor, a locating sensor, or the like. Although one sensor is illustrated, more than one sensor is possible. The information read by the sensor 66 includes distance, temperature, location, etc of a target.

FIG. 10 illustrates various types of gesture profiles. Other gestures such as tap, pinch, scroll, wave, pull, push, slide, touch and hold, using one or more fingers indicating various operating and non-operating events are possible.

The controller or processor for any embodiment herein may be a microcontroller, microprocessor, field programmable gate array (FGPA), or other suitable digital processing device. The signal generator may be a laser, audio signal emitter or any other signal generating device known in the art. Similarly, the signal receiver or sensor may be an audio receiver, laser receiver or any other suitable receiver/sensor known in the art and is typically chosen to be compatible with the signal generator.

The user interface may be tactile, visual, acoustic etc. so that information processed by the controller may be communicated to a user. In some embodiments, the user interface may include a GUI or other HMI that allows the user to program information into the controller or its associated memory.

Memory may be any suitable device known in the art and maybe incorporated in the controller itself or may be found elsewhere and this memory may store programmed instructions, sensory data, angles and offset values, a database of pressure profiles etc. as previously described herein.

The power source may be a battery, electric outlet or any motor known in the art such as a combustion engine, a pneumatically or hydraulically powered turbine or an electric motor. In some cases, the power source is separate from the motor or maybe the same as the motor. In many embodiments, the motor powers the movement of an accessory such as a drill bit, sander, etc. that is held using a chuck or other implement clamping system/tool holder.

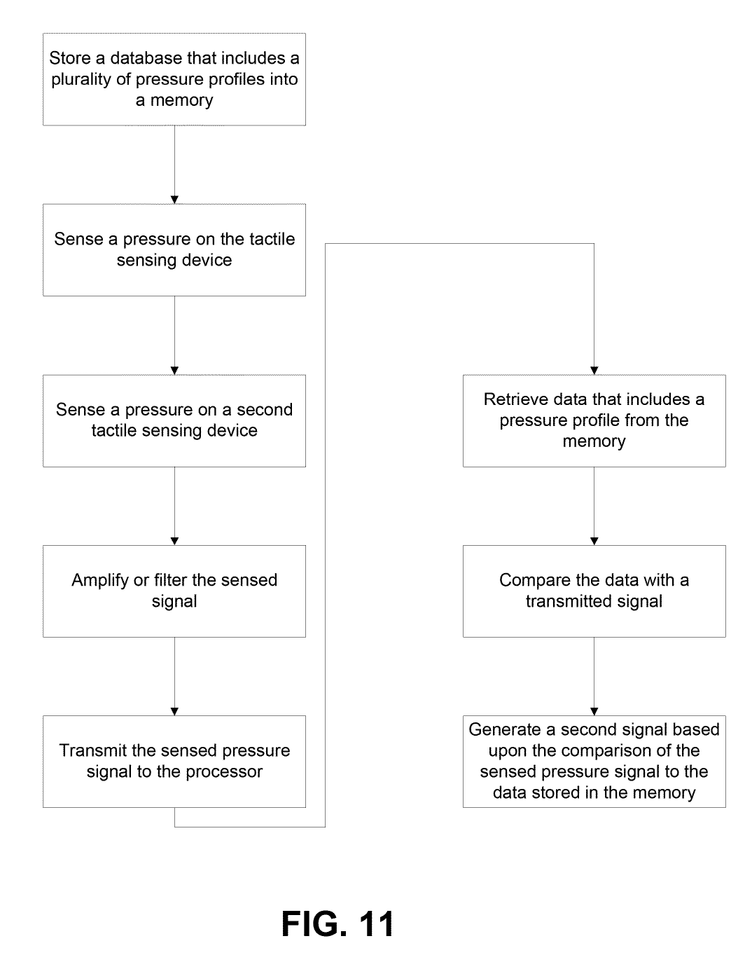

Turning now to FIG. 11, a flow chart illustrates the tactile sensing device for sensing a signal present at the power tool or the sensing tool and controlling operation of such tools. A signal is sensed on the tactile sensing device (see step 100). The sensed signal is transmitted to the processor (see step 102). Alternatively, the processor is capable of monitoring the sensed signal on the tactile device and retrieving the sensed signal from the tactile sensing device once detected. The processor retrieves data that includes a profile from memory (see step 104). The retrieved data is then compared with the sensed signal (see step 106). A second signal is generated based upon the comparison of the sensed pressure signal to the data from memory (see step 108).

In some embodiments, the second signal comprises instructions for changing a function of the tool. For example, a mode of operation such as the speed or direction of a motor for a power tool could be altered or the sensing function of the sensing tool could be changed or the tool could be placed in some warning or safety state, etc.

This method may further comprise sensing a signal on a second tactile device (see step 110), which may be used in conjunction with the first sensing step 100, after step 100, sequentially with step 100, etc. Another possible embodiment would be to amplify or filter the sensed signal before it reaches the processor (see step 112). Yet another possible embodiment would be to store a database that includes a plurality of profiles into memory (see step 114).

For any method or protocol discussed herein, any step may be omitted, combined with another step, substituted by other steps, broken into sub-steps or performed in an order that is different than has been specifically mentioned or may be performed simultaneously. Also, additional steps may be added as desired.

The specific embodiments described above have been shown by way of example, and it should be understood that these embodiments may be susceptible to various modifications and alternative forms. For example, the above disclosed embodiments and other features, functions, aspects, or alternatives thereof, may be desirably combined into many other different systems, applications or methods. Various presently unforeseen or unanticipated alternatives, modifications variations or improvements may be subsequently made by those skilled in the art that are also intended to be encompassed by the present disclosure. Furthermore, other features and aspects, etc. of certain embodiments may be substituted for or added to other features and aspects, etc. of other embodiments to produce yet further embodiments and are therefore contemplated to be within the scope of the present disclosure. It should be therefore understood that the claims are not intended to be limited to the particular forms disclosed, but rather to cover all modifications, equivalents, and alternatives falling with the sprit and scope of this disclosure.

What is claimed is:

1. A tool comprising:
a housing;
a tactile sensing device coupled to a portion of the housing, the tactile sensing device configured to detect at least one of a position sensing, gesture sensing, and pressure sensing for the tool;
a memory that is configured to store information related to a profile; and
a processor in communication with the tactile sensing device and the memory, wherein the processor is configured to monitor an output signal from the tactile sensing device when at least one of a position, gesture or pressure is detected;
the processor being further configured to retrieve the profile from the memory, compare the output signal from the tactile sensing device with the retrieved profile, and generate a second signal based upon the comparison.

2. The tool of claim 1 wherein the tactile sensing device is configured to sense at least one of position sensing, gesture sensing and pressure sensing that varies over time.

3. The tool of claim 2 wherein the pressure sensing varies in position over time.

4. The tool of claim 2 wherein the pressure sensing varies in the amount of pressure over time.

5. The tool of claim 1 wherein the profile stored in memory includes at least one of a gesture profile, position profile, contact profile, tool information, user information, instructions, sensory data, angle values, and offset values.

6. The tool of claim 1 wherein a profile stored in memory includes an amount of pressure.

7. The tool of claim 6 wherein the profile stored in memory includes a pressure gradient over time.

8. The tool of claim 1 wherein the tool is a power tool comprising a tool holder and a motor that is in communication with the memory, tactile sensing device and the processor, and wherein the processor is configured to operate the motor in a first mode of operation and a second mode of operation in response to the second signal.

9. The tool of claim 1 wherein the tool is a sensing tool.

10. The power tool of claim 8 wherein the processor compares the profile stored in memory to a signal associated with touching the tactile sensing device near one of its extremities and an associated action that is to be executed if said pressure profile is detected.

11. The power tool of claim 10 wherein the processor compares the profile stored in memory to a signal associated with touching the tactile sensing device near another one of its extremities and an associated action that is to be execute if the profile is detected.

12. The power tool of claim 11 wherein the associated actions are different depending on which extremity is touched.

13. The power tool of claim 12 wherein the first and second modes of operation include the motor running in a first direction or at a first speed and the motor running in a second direction or at a second speed.

14. The sensing tool of claim 9 further comprising a display, wherein the processor generates the second signal into human readable format for display.

15. The sensing tool of claim 14 further comprising a sensor in communication with the processor, wherein the sensor is configured to sense information external to the tool and wherein the processor is capable of processing the information sensed by the sensor and generating the sensed information into a human readable format for display.

16. The tool of claim 1 wherein the tactile sensing device includes at least one of a resistive element, a capacitive element, a magnetic element, a projected capacitive element, a flexible substrate with conductive thin film, a flexible substrate with electrode, a foldable substrate with conductive layer, a foldable substrate with electrode, and an optical based device.

17. A method for controlling a tool comprising one or more tactile sensing devices, a processor, a memory, and a power source, said method comprising:
sensing a signal on a tactile sensing device;
transmitting the sensed signal to the processor;
retrieving data including a profile from memory;
comparing the retrieved data with the sensed signal; and
generating a second signal based upon the comparison of the sensed signal that has been transmitted to the processor to the data retrieved from the memory.

18. The method of claim 17 wherein the second signal comprises instructions for changing a function of the tool.

19. The method of claim 17 further comprising sensing a signal on a second tactile device.

20. The method of claim 17 wherein the tool further comprises a motor and wherein the instructions alter the direction or speed of the motor.

21. The method of claim 17 further comprising amplifying or filtering the sensed signal.
